(19) United States
(12) Patent Application Publication
(10) Pub. No.: US 2024/0208061 A1
(43) Pub. Date: Jun. 27, 2024

(54) VERTICAL WALL CONSTRUCTION METHOD AND CONSTRUCTION ROBOT

(71) Applicant: DATA FOUNTAIN PTY LTD., SHENZHEN (CN)

(72) Inventor: YU DENG, Shenzhen (CN)

(21) Appl. No.: 18/597,915

(22) Filed: Mar. 7, 2024

Related U.S. Application Data
(63) Continuation of application No. PCT/CN2022/109638, filed on Aug. 2, 2022.

(30) Foreign Application Priority Data
Sep. 7, 2021 (CN) 202111045993.0

(51) Int. Cl. B25J 9/16; B25J 11/00

(52) U.S. Cl. CPC B25J 9/1666; B25J 9/1697; B25J 11/005

(57) ABSTRACT

The present invention discloses a vertical wall construction method and construction robot. The vertical wall construction method includes steps: constructing, by a construction module, an interior vertical wall; detecting an obstacle in a construction direction to obtain a position and size information of the obstacle; and determining a type of the obstacle, planning a construction path, avoiding the obstacle, and determining a reconstruction position based on the position and the size information of the obstacle. The robot includes a sensing module, a control module, and a construction module; the sensing module is configured to detect a position and size information of an obstacle and determine a type of the obstacle; the control module is configured to plan a construction path; and the construction module is configured to carry out construction of a predetermined ceiling wall based on a construction path planned by a planning apparatus.

### CROSS REFERENCE TO RELATED APPLICATION

This application is a continuation of International Patent Application No. PCT/CN2022/109638 with a filing date of Aug. 2, 2022, designating the United States, now pending, and further claims priority to Chinese patent application CN202111045993.0 with a filing date of Sep. 7, 2021. The content of the aforementioned applications, including any intervening amendments thereto, are incorporated herein by reference.

### TECHNICAL FIELD

The present invention relates to the technical field of construction robots, and in particular, to a vertical wall construction method and construction robot.

### TECHNICAL BACKGROUND

With development of intelligent technologies in the construction industry, various construction robots have emerged to replace manual labor and implement safe and efficient construction. For example, the adsorption facade cleaning robot is adhered to an exterior wall through adsorption structures such as electrostatic adsorption, magnetic adsorption, and vacuum adsorption so that a robot construction module performs operations such as polishing and cleaning on the exterior wall. For a bucket facade cleaning robot, a fixing structure is disposed on a top floor and a bucket is lowered. The bucket is equipped with a construction apparatus, to complete polishing, cleaning, and other operations on the exterior wall in a vertical lifting process. A lifting wall treatment device includes polishing, putty applying, and painting devices with single function, and each time the device is lifted, a construction apparatus is lifted. During lifting, the construction apparatus completes polishing, putty applying, and painting functions in the vertical direction.

An existing lifting automation device cannot avoid an obstacle in a vertical lifting direction, or automatically plan a horizontal movement distance, and therefore, does not have an intelligent construction capability. However, interior wall treatment parts include: polishing of a cement wall to remove burrs of the cement wall; applying of putty on the cement wall, where a putty layer makes the entire wall smoother; polishing of the wall with the putty layer, removal of seams of the putty layer, and so on to flatten the putty layer; and spraying or painting on the putty layer. During construction, non-construction areas should be avoided, for example, doors, windows, obstacles and non-construction areas designated by apartment owners.

Existing adsorption facade cleaning robots are not suitable for interior wall construction scenarios, and if the walls are non-magnetic and relatively rough, the adsorption facade cleaning robots cannot be adsorbed onto the walls. Existing bucket facade cleaning robots are not suitable for interior wall construction scenarios because a height of a disposed bucket accounts for nearly 30% of 0-6 m interior height.

Obstacles divide the vertical walls into different parts, and about 50% of the parts include doors, windows, switches and other obstacles. If the obstacles cannot be identified intelligently, even if a device can carry out construction automatically, a lot of manual labor is still required, and construction efficiency is still not substantially improved.

### SUMMARY

Obstacles divide the vertical walls into different parts, and about 50% of the parts include doors, windows, switches and other obstacles. If the obstacles cannot be identified intelligently, even if a device can carry out construction automatically, a lot of manual labor is still required, and construction efficiency is low.

In view of the foregoing problems, a vertical wall construction method and construction robot are proposed, to learn a position and size information of an obstacle by detecting the obstacle in a vertical wall construction process, to determine a type of the obstacle so that a construction module of the construction robot is guided to avoid the obstacle and continue construction, thereby improving construction efficiency of the construction robot and resolving a problem that an existing construction robot cannot avoid the obstacle during the construction of the vertical wall.

A vertical wall construction method, including steps:
constructing, by a construction module, an interior vertical wall so that a construction direction of the construction module is parallel to the vertical wall; detecting an obstacle encountered in a construction process to obtain a position and size information of the obstacle; and
determining a type of the obstacle, planning a construction path, avoiding the obstacle, and determining a reconstruction position based on the position and the size information of the obstacle.

With reference to the vertical wall construction method in the present invention, in a first possible embodiment, the construction method further includes steps:
detecting, by a sensing module, a wall covered during construction to obtain a construction effect; and
determining a proportion of an overlapped area during two adjacent constructions based on the construction effect.

With reference to the first possible embodiment in the present invention, in a second possible embodiment, the steps of constructing, by a construction module, an interior vertical wall so that a construction direction of the construction module is parallel to the vertical wall include sub-steps:
moving, by the construction robot, to a vertical wall to be constructed based on a path plan; and
driving, by a lifting unit, the construction module to carry out construction in a direction parallel to the vertical wall.

With reference to the second possible embodiment in the present invention, in a third possible embodiment, the steps of determining a type of the obstacle, planning a construction path, avoiding the obstacle, and determining a reconstruction position based on the position and the size information of the obstacle include sub-steps:
detecting, by the sensing module, the position and the size information of the obstacle in the construction process, and determining the type of the obstacle;
if the obstacle is a first obstacle, measuring a vertical distance from the construction module to the first obstacle; and
determining an end position of the construction module based on the vertical distance, where
the first obstacle is a ceiling or a top obstacle.

With reference to the second possible embodiment in the present invention, in a fourth possible embodiment, the steps of determining a type of the obstacle, planning a construction path, avoiding the obstacle, and determining a reconstruction position based on the position and the size information of the obstacle further include sub-steps:
calculating a first position and size information of a second obstacle if the obstacle is the second obstacle; and
determining an endpoint position of the current construction, a retreat distance required to avoid the second obstacle, and a reconstruction start position based on the
first position and the size information, where
the second obstacle is an obstacle on the vertical wall.

With reference to the fourth possible embodiment in the present invention, in a fifth possible embodiment, the steps of calculating a first position and size information of a second obstacle if the obstacle is the second obstacle include sub-steps:
returning an abscissa X and an ordinate Y of the second obstacle relative to a coordinate system of the construction module; and
calculating the size information of the second obstacle, where the size information includes a horizontal length Wb, a vertical height H, and a protrusion height T relative to the vertical wall.

With reference to the second possible embodiment in the present invention, in a sixth possible embodiment, the steps of determining a type of the obstacle, planning a construction path, avoiding the obstacle, and determining a reconstruction position based on the position and the size information of the obstacle further include sub-steps:
measuring a distance from the current position to a vertical wall connected with a third obstacle if the obstacle is the third obstacle; and
determining whether the connected vertical wall is a constructed wall and calculating a required horizontal movement route and distance W3 based on a path plan, where the third obstacle is an internal angle or an external angle of the wall.

With reference to the vertical wall construction method in the present invention, in a seventh possible embodiment, before the step of constructing, by a construction module, an interior vertical wall so that a construction direction of the construction module is parallel to the vertical wall, the vertical wall construction method includes steps:
setting a coverage width W1 in one construction of the construction module; and
setting a horizontal construction speed V of the construction module.

A vertical wall construction robot, including:
a sensing module;
a control module; and
a construction module, where
the sensing module is communicatively connected with the control module and is configured to detect a position and size information of an obstacle in the construction process, and determine a type of the obstacle;
the control module is configured to plan a construction path based on a type, a position, and size information of the obstacle, to avoid the obstacle and carry out construction; and
the construction module is configured to carry out construction of a predetermined ceiling wall based on a construction path planned by the control module, and the construction module includes:
an AGV navigation unit;
a vertical lifting unit; and
a horizontal movement unit, where
the vertical lifting unit is configured to vertically move the construction module to a position at a construction height H that is close to a ceiling wall to carry out construction; and
the horizontal movement unit is configured to drive the construction module to move horizontally based on a planned path or a control instruction to carry out construction of a corresponding ceiling wall; and the AGV navigation unit is configured to provide navigation for a horizontal movement and a vertical movement of the entire robot or the construction module.

With reference to the vertical wall construction robot in the present invention, in a first possible embodiment, obstacles detected by the sensing module include a first obstacle, a second obstacle, and a third obstacle, the first obstacle is a ceiling or a top obstacle, the second obstacle is an obstacle on the vertical wall, and the third obstacle is an internal/external angle obstacle on the wall.

The vertical wall construction method and construction robot in the present invention are implemented, to learn a position and size information of an obstacle by detecting the obstacle in a vertical wall construction process, to determine a type of the obstacle so that a construction module of the construction robot is guided to avoid the obstacle and continue construction, thereby improving construction efficiency of the construction robot and resolving a problem that an existing construction robot cannot avoid the obstacle during the construction of the vertical wall.

### BRIEF DESCRIPTION OF THE DRAWINGS

To illustrate the technical solution in embodiments in the present invention more clearly, the following briefly introduces the accompanying drawings required for description of the embodiments. Obviously, the accompanying drawings in the following description are only some embodiments in the present invention. Those of ordinary skill in the art may still derive other drawings from these accompanying drawings without creative efforts.

FIG. 1 is a schematic diagram of Embodiment 1 of a vertical wall construction method according to the present invention;

FIG. 2 is a schematic diagram of Embodiment 2 of a vertical wall construction method according to the present invention;

FIG. 3 is a schematic diagram of Embodiment 3 of a vertical wall construction method according to the present invention;

FIG. 4 is a schematic diagram of Embodiment 4 of a vertical wall construction method according to the present invention;

FIG. 5 is a schematic diagram of Embodiment 5 of a vertical wall construction method according to the present invention;

FIG. 6 is a schematic diagram of Embodiment 6 of a vertical wall construction method according to the present invention;

FIG. 7 is a schematic diagram of Embodiment 7 of a vertical wall construction method according to the present invention;

FIG. 8 is a schematic diagram of Embodiment 8 of a vertical wall construction method according to the present invention;

FIG. 9 is a schematic composition diagram of an embodiment of a vertical wall construction robot according to the present invention; and

FIG. 10 is a schematic composition diagram of an embodiment of a construction module of a vertical wall construction robot according to the present invention.

Names of components denoted by numbers in accompanying drawings: 100, vertical wall construction robot; 110, sensing module; 120, control module; 130, construction module; 131, AGV navigation unit; 132, vertical lifting unit; and 133, horizontal movement unit.

### DETAILED DESCRIPTION OF EMBODIMENTS

The following clearly and completely describes the technical solutions in the present invention with reference to the accompanying drawings in the present invention. Apparently, the described embodiments are some but not all of the embodiments of the present invention. Other embodiments obtained by those of ordinary skill in the art based on the embodiments of the present invention without creative efforts shall fall within the protection scope of the present invention.

Obstacles divide the vertical walls into different parts, and about 50% of the parts include doors, windows, switches and other obstacles. If the obstacles cannot be identified intelligently, even if a device can carry out construction automatically, a lot of manual labor is still required, and construction efficiency is low.

In view of the foregoing problems, a vertical wall construction method and construction robot 100 are proposed.

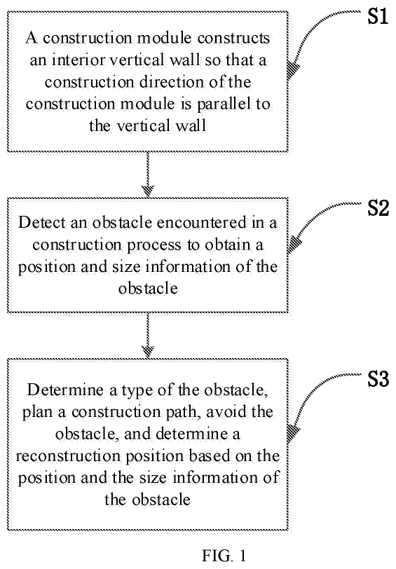

A vertical wall construction method is provided. As shown in FIG. 1, FIG. 1 is a schematic diagram of Embodiment 1 of a vertical wall construction method according to the present invention. The vertical wall construction method includes the following steps.

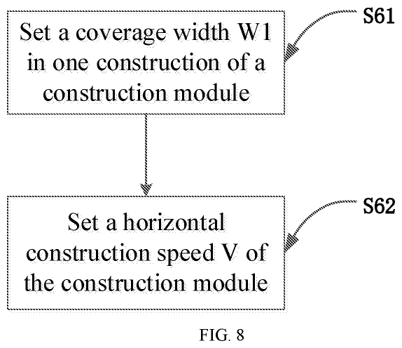

Preferably, as shown in FIG. 8, FIG. 8 is a schematic diagram of Embodiment 8 of a vertical wall construction method according to the present invention. Before step S1, the vertical wall construction method includes steps:

S61. Set a coverage width W1 in one construction of a construction module 130.

S62. Set a horizontal construction speed V of the construction module 130.

Generally, there are construction types such as polishing of a wall, putty applying, and painting. The vertical wall refers to an internal partition wall, and a vertical movement speed V in the construction direction determines a thickness of polishing, a thickness of putty, and a thickness of the paint. The greater the speed, the smaller the thickness. The construction coverage width W1 is a width in one construction. In order to ensure that there is no obvious seam between the two constructions, 10% of areas generally need to be overlapped in two consecutive constructions.

S1. A construction module 130 constructs an interior vertical wall so that a construction direction of the construction module 130 is parallel to the vertical wall.

The construction direction of the construction module 130 is parallel to the vertical wall, and the vertical lifting unit 132 drives the construction module 130 to perform a lifting movement along the vertical direction to carry out construction.

S2. Detect an obstacle encountered in a construction process to obtain a position and size information of the obstacle.

The sensing module 110 detects the position and size information of the obstacle in the construction direction, and the sensing module 110 may include two sensing units, and the sensing unit can be composed of one or more of LiDAR, a millimeter-wave radar, an ultrasonic radar, an in-depth camera, an RGB camera, and an infrared camera. The sensing unit transmits data to the control module 120, and the control module 120 calculates the data, to plan the construction path. The control module 120 includes a CPU or a GPU, and the control module 120 plans the construction path and transmits an instruction to the construction module 130 through a communication unit, to move and carry out construction.

S3. Determine a type of the obstacle, plan a construction path, avoid the obstacle, and determine a reconstruction position based on the position and the size information of the obstacle.

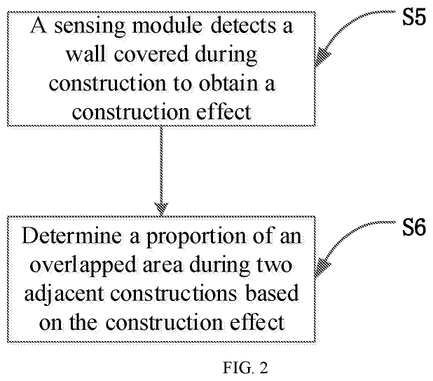

Preferably, as shown in FIG. 2, FIG. 2 is a schematic diagram of Embodiment 2 of a vertical wall construction method according to the present invention. The construction method further includes steps:

S4. A sensing module 110 detects a wall covered during construction to obtain a construction effect.

S5. Determine a proportion of an overlapped area during two adjacent constructions based on the construction effect.

A vertical movement speed V in the construction direction determines a thickness of polishing, a thickness of putty, and a thickness of the paint. The greater the speed, the smaller the thickness. The construction coverage width is W1. In order to ensure that there is no obvious seam between the two constructions, partial regions in two adjacent construction regions need to be overlapped, and an overlapping range can be 10% to 30%.

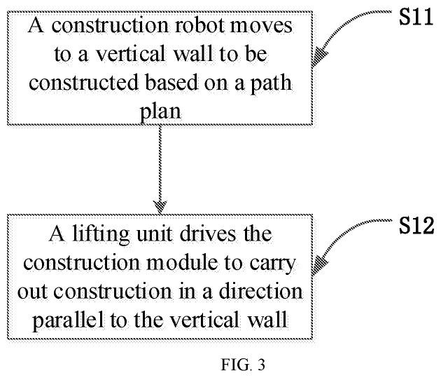

Preferably, as shown in FIG. 3, FIG. 3 is a schematic diagram of Embodiment 3 of a vertical wall construction method according to the present invention. Step S1 includes sub-steps:

S11. The construction robot 100 moves to a vertical wall to be constructed based on a path plan.

S12. A lifting unit drives the construction module 130 to carry out construction in a direction parallel to the vertical wall.

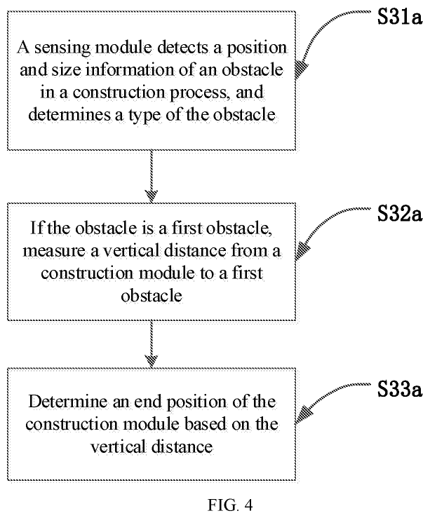

Preferably, as shown in FIG. 4, FIG. 4 is a schematic diagram of Embodiment 4 of a vertical wall construction method according to the present invention. Step S3 includes sub-steps:

S31a. The sensing module 110 detects the position and the size information of the obstacle in the construction process, and determines the type of the obstacle.

S32a. If the obstacle is a first obstacle, measure a vertical distance from the construction module 130 to the first obstacle.

S33a. Determine an end position of the construction module 130 based on the vertical distance.

The first obstacle is a ceiling or a top obstacle.

If the sensing module 110 detects that there is a ceiling in front, the control module 120 plans the construction path. Specifically, the control module 120 calculates a current distance Dceiling between the construction module 130 and the ceiling, and further determines an end position Dceiling-end of the current construction.

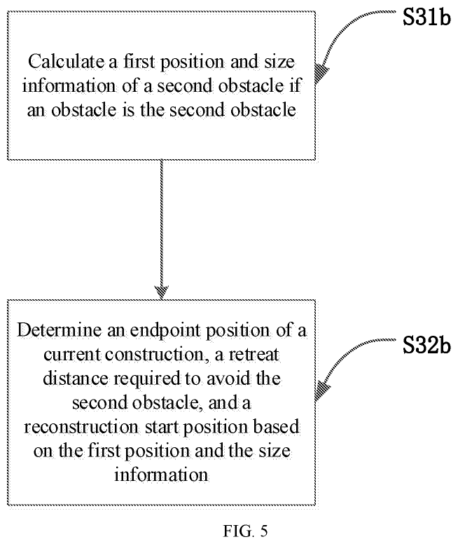

Preferably, as shown in FIG. 5, FIG. 5 is a schematic diagram of Embodiment 5 of a vertical wall construction method according to the present invention. Step S3 further includes sub-steps:

S31b. Calculate a first position and size information of a second obstacle if the obstacle is the second obstacle.

S32b. Determine an endpoint position of the current construction, a retreat distance required to avoid the second obstacle, and a reconstruction start position based on the first position and the size information.

The second obstacle is an obstacle on the vertical wall.

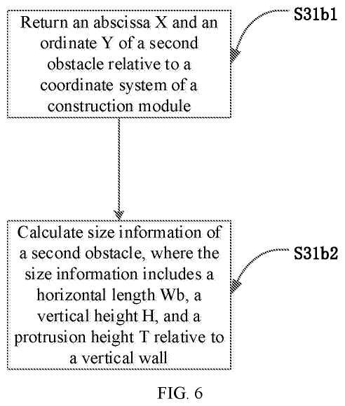

Preferably, as shown in FIG. 6, FIG. 6 is a schematic diagram of Embodiment 6 of a vertical wall construction method according to the present invention. Step S31b includes sub-steps:

S31b1. Return an abscissa X and an ordinate Y of the second obstacle relative to a coordinate system of the construction module 130.

S31b2. Calculate the size information of the second obstacle, where the size information includes a horizontal length Wb, a vertical height H, and a protrusion height T relative to the vertical wall.

The obstacle protruding from the interior side wall accounts for about 50% of an overall area. The position and the size information of the obstacle are learned by detecting the obstacle in the vertical wall construction process, to determine the type of the obstacle so that the construction module 130 of the construction robot 100 is guided to avoid the obstacle and continue construction, thereby improving the construction efficiency of the construction robot 100 and resolving the problem that the existing construction robot 100 cannot avoid the obstacle during the construction of the vertical wall.

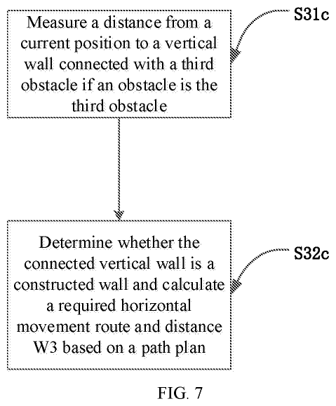

Preferably, as shown in FIG. 7, FIG. 7 is a schematic diagram of Embodiment 7 of a vertical wall construction method according to the present invention. Step S3 further includes sub-steps:

S31c. Measure a distance from the current position to a vertical wall connected with a third obstacle if the obstacle is the third obstacle. S32c. Determine whether the connected vertical wall is a constructed wall and calculate a required horizontal movement route and distance W3 based on a path plan.

The third obstacle is an internal angle or an external angle of the wall.

If it is detected that the current wall ends within a range of a horizontal movement WMOVE-setting after one construction is completed, that is, the wall begins to form a corner, when the corner is at an internal angle, a distance from the next surface to the robot is measured, it is calculated whether to continue the construction, and an actual value WMOVE-1 of a horizontal movement distance is calculated.

If it is detected that the current wall ends within a range of a horizontal movement WMOVE-setting after one construction is completed, that is, the wall begins to form a corner, when the corner is at an external angle, a distance from the next surface to the robot is measured, it is calculated whether to continue the construction, and an actual value WMOVE-1 of a horizontal movement distance is calculated.

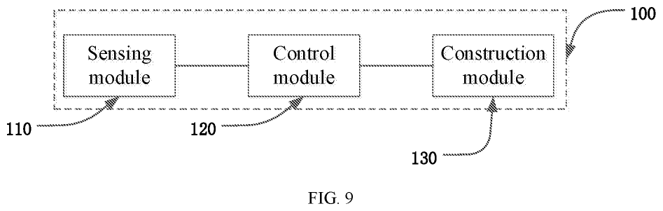

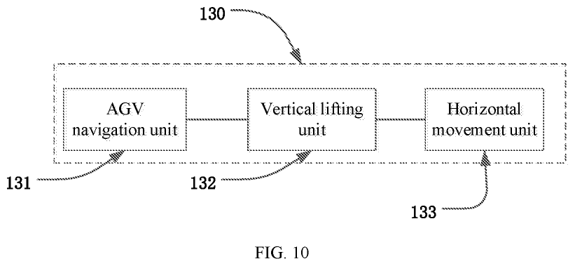

A vertical wall construction robot 100 is provided. A shown in FIG. 9, FIG. 9 is a schematic composition diagram of an embodiment of a vertical wall construction robot 100 according to the present invention. The vertical wall construction robot 100 includes a sensing module 110, a control module 120, and a construction module 130; the sensing module 110 is communicatively connected with the control module 120 and is configured to detect a position and size information of an obstacle in the construction process, and determine a type of the obstacle; and the control module 120 is configured to plan a construction path based on a type, a position, and size information of the obstacle, to avoid the obstacle and carry out construction. The construction module 130 is configured to carry out construction of a predetermined ceiling wall based on a construction path planned by the control module. As shown in FIG. 10, FIG. 10 is a schematic composition diagram of an embodiment of a construction module 130 of a vertical wall construction robot 100 according to the present invention. The construction module 130 includes an AGV navigation unit 131, a vertical lifting unit 132, and a horizontal movement unit 133; the vertical lifting unit 132 is configured to vertically move the construction module 130 to a position at a construction height H that is close to a ceiling wall to carry out construction; the horizontal movement unit 133 is configured to drive the construction module 130 to move horizontally based on a planned path or a control instruction to carry out construction of a corresponding ceiling wall; and the AGV navigation unit 131 is configured to provide navigation for a horizontal movement and a vertical movement of the entire robot 100 or the construction module 130.

Obstacles detected by the sensing module 110 include a first obstacle, a second obstacle, and a third obstacle, the first obstacle is a ceiling or a top obstacle, the second obstacle is an obstacle on the vertical wall, and the third obstacle is an internal/external angle obstacle on the wall.

The vertical wall construction method and construction robot 100 in the present invention are implemented, to learn the position and the size information of the obstacle by detecting the obstacle in the vertical wall construction process, to determine the type of the obstacle so that the construction module 130 of the construction robot 100 is guided to avoid the obstacle and continue construction, thereby improving the construction efficiency of the construction robot 100 and resolving the problem that the existing construction robot 100 cannot avoid the obstacle during the construction of the vertical wall.

The foregoing descriptions are merely preferred embodiments of the present invention, and are not intended to limit the present invention. Any modifications, equivalent replacements, improvements, and the like made within the spirit and principle of the present invention shall all fall within the protection scope of the present invention.

The present invention discloses a vertical wall construction method and construction robot. The vertical wall construction method includes steps: constructing, by a construction module, an interior vertical wall; detecting an obstacle in a construction direction to obtain a position and size information of the obstacle;

and determining a type of the obstacle, planning a construction path, avoiding the obstacle, and determining a reconstruction position based on the position and the size information of the obstacle. The robot includes a sensing module, a control module, and a construction module; the sensing module is configured to detect a position and size information of an obstacle and determine a type of the obstacle; the control module is configured to plan a construction path; and the construction module is configured to carry out construction of a predetermined ceiling wall based on a construction path planned by a planning apparatus. The present invention is implemented, to learn the position, the size information, and the type of the obstacle by detecting the obstacle in the vertical wall construction process so that a construction module is guided to avoid the obstacle and continue construction, thereby improving efficiency of the construction robot and resolving a problem that the obstacle cannot be avoided to carry out construction.

I claim:

1. A vertical wall construction method, comprising steps:
constructing, by a construction module, an interior vertical wall so that a construction direction of the construction module is parallel to the vertical wall;
detecting an obstacle encountered in a construction process to obtain a position and size information of the obstacle; and
determining a type of the obstacle, planning a construction path, avoiding the obstacle, and determining a reconstruction position based on the position and the size information of the obstacle.

2. The vertical wall construction method according to claim 1, wherein the construction method further comprises steps:
detecting, by a sensing module, a wall covered during construction to obtain a construction effect; and
determining a proportion of an overlapped area during two adjacent constructions based on the construction effect.

3. The vertical wall construction method according to claim 2, wherein the steps of constructing, by a construction module, an interior vertical wall so that a construction direction of the construction module is parallel to the vertical wall comprise sub-steps:
moving, by the construction robot, to a vertical wall to be constructed based on a path plan; and
driving, by a lifting unit, the construction module to carry out construction in a direction parallel to the vertical wall.

4. The vertical wall construction method according to claim 3, wherein the steps of determining a type of the obstacle, planning a construction path, avoiding the obstacle, and determining a reconstruction position based on the position and the size information of the obstacle comprise sub-steps:
detecting, by the sensing module, the position and the size information of the obstacle in the construction process, and determining the type of the obstacle;
if the obstacle is a first obstacle, measuring a vertical distance from the construction module to the first obstacle; and
determining an end position of the construction module based on the vertical distance, wherein
the first obstacle is a ceiling or a top obstacle.

5. The vertical wall construction method according to claim 3, wherein the steps of determining a type of the obstacle, planning a construction path, avoiding the obstacle, and determining a reconstruction position based on the position and the size information of the obstacle further comprise sub-steps:
calculating a first position and size information of a second obstacle if the obstacle is the second obstacle; and
determining an endpoint position of the current construction, a retreat distance required to avoid the second obstacle, and a reconstruction start position based on the first position and the size information, wherein
the second obstacle is an obstacle on the vertical wall.

6. The vertical wall construction method according to claim 5, wherein the steps of calculating a first position and size information of a second obstacle if the obstacle is the second obstacle comprise sub-steps:
returning an abscissa X and an ordinate Y of the second obstacle relative to a coordinate system of the construction module; and
calculating the size information of the second obstacle, wherein the size information comprises a horizontal length Wb, a vertical height H, and a protrusion height T relative to the vertical wall.

7. The vertical wall construction method according to claim 3, wherein the steps of determining a type of the obstacle, planning a construction path, avoiding the obstacle, and determining a reconstruction position based on the position and the size information of the obstacle further comprise sub-steps:
measuring a distance from the current position to a vertical wall connected with a third obstacle if the obstacle is the third obstacle; and
determining whether the connected vertical wall is a constructed wall and calculating a required horizontal movement route and distance W3 based on a path plan, wherein the third obstacle is an internal angle or an external angle of the wall.

8. The vertical wall construction method according to claim 1, wherein before the step of constructing, by a construction module, an interior vertical wall so that a construction direction of the construction module is parallel to the vertical wall, the vertical wall construction method comprises steps:
setting a coverage width W1 in one construction of the construction module; and
setting a horizontal construction speed V of the construction module.

9. A vertical wall construction robot, comprising:
a sensing module;
a control module; and
a construction module, wherein
the sensing module is communicatively connected with the control module and is configured to detect a position and size information of an obstacle in the construction process, and determine a type of the obstacle;
the control module is configured to plan a construction path based on a type, a position, and size information of the obstacle, to avoid the obstacle and carry out construction; and
the construction module is configured to carry out construction of a predetermined ceiling wall based on a construction path planned by the control module, and the construction module comprises:
an AGV navigation unit;
a vertical lifting unit; and
a horizontal movement unit, wherein
the vertical lifting unit is configured to vertically move the construction module to a position at a construction height H that is close to a ceiling wall to carry out construction; and
the horizontal movement unit is configured to drive the construction module to move horizontally based on a planned path or a control instruction to carry out construction of a corresponding ceiling wall; and the AGV navigation unit is configured to provide navigation for a horizontal movement and a vertical movement of the entire robot or the construction module.

10. The vertical wall construction robot according to claim 9, wherein obstacles detected by the sensing module comprise a first obstacle, a second obstacle, and a third obstacle, the first obstacle is a ceiling or a top obstacle, the second obstacle is an obstacle on the vertical wall, and the third obstacle is an internal/external angle obstacle on the wall.
